(19) United States
(12) Patent Application Publication
(10) Pub. No.: US 2026/0116831 A1
(43) Pub. Date: Apr. 30, 2026

(54) BANANA BIOMASS SOIL ADDITIVE

(71) Applicant: Christopher Curzon, Charlotte, NC (US)

(72) Inventor: Christopher Curzon, Charlotte, NC (US)

(21) Appl. No.: 19/362,018

(22) Filed: Oct. 17, 2025

Related U.S. Application Data
(60) Provisional application No. 63/711,984, filed on Oct. 25, 2024.

(51) Int. Cl. C05F 5/00; C05F 17/30

(52) U.S. Cl. CPC C05F 5/002; C05F 17/30

(57) ABSTRACT

A method for creating a banana biomass. The method comprises separating the fibrous and non-fibrous materials of at least one portion of a banana plant from the sap. The method also includes pressing the fibrous and nonfibrous materials and drying the fibrous and nonfibrous materials.

### CROSS-REFERENCE TO RELATED APPLICATIONS

This application claims the benefit of and priority to U.S. Provisional Patent Application Ser. No. 63/711,984 filed on Oct. 25, 2024, which application is incorporated herein by reference in its entirety.

### BACKGROUND OF THE INVENTION

Climate change has and continues to result in changes in weather conditions which causes challenges to agriculture, horticulture, landscaping, green spaces and properties. Many areas that have historically had sufficient moisture are now more often subject to drought. Other areas are arid and have continuously struggled with sufficient water to meet growing populations and maintain agriculture and horticulture.

With these challenges, there is a growing need for new and innovative ways to deal with the water shortages that so many areas face and simultaneously maintain agriculture and horticulture industries.

The market provides a number of soil amendments, garden mixes, soils and fillers that each have unique characteristics. A soil amendment is any material added to soil to improve its physical properties, such as structure, drainage, water retention, or nutrient content. The goal of using a soil amendment is to create a healthier environment for plant roots, leading to better plant growth. The vast majority of soil mixes and amendments are made from forest products, e.g., tree bark and tree biomass. The main focus of these materials is to improve plant health, improve soil and increase yields and plant growth. One of the most used products for horticulture and agriculture is peat moss. Peat moss is also known as sphagnum peat moss or simply sphagnum moss and is a type of organic material that forms in peat bogs over thousands of years. It is composed mainly of decomposed plant material, primarily mosses from the genus Sphagnum. Peat moss is commonly found in cool, wet, and acidic environments, such as bogs and marshes.

While peat moss has a large market, it also comes with a number of challenges and growing concerns. One of the greatest concerns with peat moss is the fact that when it is harvested, it releases significant carbon dioxide (CO2) into the atmosphere. Indeed, the annual released carbon dioxide from the harvesting of peat moss is two times as much carbon dioxide that is released from the airline industry in a year. Moreover, peat moss is non-renewable—it takes a thousand years simply to develop, and, it contains mold, mildew spores, and fungal disease. Finally, peat moss is highly hydrophobic; it resists water and consequently only functions as a soil amendment when it is treated with surfactants or wetting agents. Many countries in the European Union have begun to ban peat moss for retail uses. Moreover, several countries have proceeded to terminate all extraction of peat moss.

In addition to peat moss, coconut coir has grown in popularity and is replacing peat moss in a number of applications. However, like peat moss, coconut coir has limitations and challenges. First, coconut coir is likewise hydrophobic. In order for it to absorb water, it must be treated with a surfactant or a wetting agent. Second, coconut coir tends to expand when wet which can create problems for potting and landscaping. Finally, coconut coir dries very quickly, and when it dries, it is powdery and easily blows away or disintegrates. Coconut coir is not available on the scale of peat moss which results in higher costs.

Accordingly, there is a need for alternatives to wood-based soil amendments, coconut coir and peat moss for agriculture and horticulture. In particular, there have been no novel soil amendments introduced to the markets beyond the afore-referenced materials in more than 25 years. One of the most abundant natural biomass materials in the world is the biomass generated from banana plants.

Banana pseudostems, more often referred to as the “trunks,” have never been harvested as an organic material on an industrial scale. While the fiber extracted from the pseudostems have been used for artisan purposes by individuals and communities and for limited applications in textiles there are numerous hurdles to industrializing the production of banana biomass for international commercial and consumer use as an advanced soil additive in agriculture and horticulture and for other applications in the textile and nonwoven industries.

Common banana varieties including cavandish, and its sub-varieties, and plantain, and its sub-varieties, have not been industrialized on any scale and represent well over ninety-eight percent (98.0%) of all bananas grown in the world. Accordingly, there is a need in the art for the use of banana biomass for the agriculture and horticulture industries.

Up to the point of our development of applications and technologies using the banana fiber and pseudostem for products, well over ninety-eight percent (98.0%) of all banana pseudostems have remained in the fields as organic waste. A number of scientific papers have concluded that one of the greatest wastes of a natural organic material is that of banana plants because they are available in virtually unlimited quantities but have never been commercially exploited for their unique characteristics and thereby commercialized.

While the sap from banana pseudostems has been used in various fertilizer applications, the actual use of the pseudostems, i.e., the biomass material that makes up the pseudostem, for commercial applications as a soil amendment on an industrial and commercial basis has not been done. We have spent the last four years analyzing, testing and studying banana biomass derived from the pseudostems of the banana plant as an advanced soil additive.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method for creating a banana biomass. The method comprises separating the fibrous and non-fibrous materials of at least one portion of a banana plant from the sap. The method also includes pressing the fibrous and nonfibrous materials and drying the fibrous and nonfibrous materials.

Another example embodiment includes a method for creating a banana biomass. The method comprises separating the fibrous materials of at least one portion of a banana plant from the nonfibrous materials and sap and separating the nonfibrous materials from the sap. The method also includes pressing the nonfibrous materials and drying the nonfibrous materials. The method further includes shredding the nonfibrous materials and sterilizing the nonfibrous materials.

Another example embodiment includes the method for creating a banana biomass. The method comprises using one portion of the banana plant including all fibrous and nonfibrous materials and separating them from the sap. The method includes pressing the materials to remove all sap and drying the material. The method further includes shredding the material (fibrous and nonfibrous) and sterilizing the material.

Another example embodiment includes an advanced soil additive. The soil amendment comprises nonfibrous banana biomass. The nonfibrous banana biomass has been obtained by the steps of separating the fibrous materials of at least one portion of a banana plant from the nonfibrous materials and sap and separating the nonfibrous materials from the sap. The method also includes pressing the nonfibrous materials and drying the nonfibrous materials.

Another example embodiment includes an advanced soil additive. The advanced soil additive comprises fibrous and nonfibrous banana biomass. The biomass material has been obtained by the steps of separating the banana biomass material from the sap. The method also includes pressing the biomass material and drying the material. The material is then processed through shredding to a predetermined size.

Another example embodiment includes an advanced soil additive. The advanced soil additive comprises fibrous and nonfibrous banana biomass. The method includes the process of shredding the fibrous and nonfibrous material, prior to extraction of the water sap. Thereafter, the material is dried through an industrial dryer system.

These and other objects and features of the present invention will become more fully apparent from the following description and appended claims or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flow-chart illustrating an example of a method for creating a banana biomass soil additive; and

FIG. 2 is a flow-chart illustrating an example of an alternative method for creating a banana biomass soil additive.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

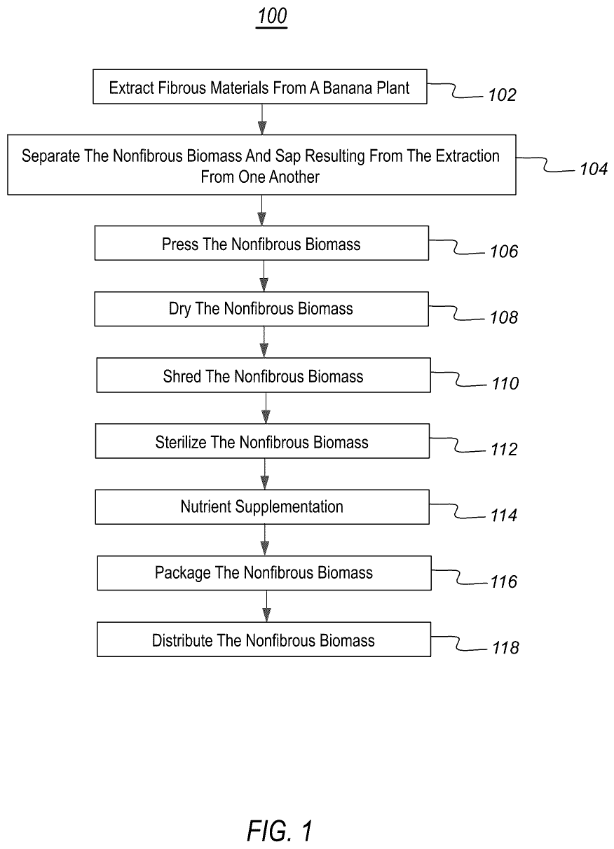

FIG. 1 is a flow-chart illustrating an example of a method 100 for creating a banana biomass soil additive. The use of banana biomass originating from banana plants that is converted to an advanced soil additive for use in horticulture, agriculture, commercial or residential landscaping, municipalities for use on green spaces, medians and parks, and greenhouses, nurseries and other commercial applications. The banana biomass has six principal characteristics: 1) it can be processed to retain its unique and substantial capacity to retain and store water in its material, 2) it is hydrophilic in that it readily absorbs water without expanding or contracting, 3) it is a thermal conductor which causes it to reduce soil temperature in extreme heat and also reduce water evaporation, 4) it is antimicrobial which means that it eliminates, or nearly eliminates, the growth of mold, mildew or fungus, 5) it is a dry surfactant or wetting agent which means that it functions to help hydrophobic materials absorb water, and 6) it has a high nutrient level that provides nitrogen, phosphorus, potassium, boron, magnesium and other micro organics to the soil and plants. The banana biomass may be infused or mixed with additional micronutrients or other minerals. The banana biomass contains fiber, lignin, pectin and other nutrients.

The benefits of the banana biomass include:
Revitalizes soil and plant health
Nutrient rich, antibacterial, hypoallergenic
Disease resistant—does not grow mold, fungus or mildew
Thermal conductor to reduce heat and evaporation
Immense capacity to retain and store water
Natural dry surfactant or wetting agent
Reduces actual water usage
Provides structure and porosity
Reduces water irrigation demand by 20% or more
Sustainable
Renewable—grows 365 days a year and results in 3.8 harvests a year
Virtually unlimited quantity available from Central and Latin America, India and parts of Asia
Low production cost

The banana biomass provides a new and innovative material for the afore-described markets. Because banana plants grow quickly, banana biomass can be produced inexpensively and is available in extremely high quantities in Central America, South America and Asia.

The banana biomass is a modified organic material originating from the pseudostem of a banana plant. The pseudostem of the banana plant is more commonly known as the “trunk” of the banana plant—banana plants are not trees but are technically herbs that die upon harvest of the fruit. The banana biomass may be treated, sterilized and infused with additional fertilizers and organics in order to promote a material that has an immense capacity to store and conserve water and provide significant nutrients to crops, trees, ornamentals and plant materials for the purpose of promoting plant health, water conservation and larger yields.

The basis of this application is not the use of banana plants or biomass from the plants in their existing form. As described below and demonstrated through the claims, the scope of the invention is the conversion of the banana plant into a dry biomass material that is useable and has distinct observable benefits in the agriculture and horticulture industries which would otherwise not exist except for the mechanical conversion and processes that are described throughout this application.

FIG. 1 shows that the method 100 can include extracting 102 fibrous materials from the banana organic materials. Extraction 102 primarily involves the separation of the fibrous strands found in the pseudostem and leaves of the banana organic materials from non-fibrous portions. The pseudostem consists of tightly packed layers of leaf sheaths, which contain a considerable amount of fiber. Extraction 102 results in obtaining fibrous material and a combination of nonfibrous material and banana sap. Because the banana organic materials consist of approximately eighty percent water, significant water sap is stored in the banana organic materials and released.

By way of explanation, banana plants consist of a pseudostem or “trunk,” which is not a true stem but rather a collection of tightly packed leaf sheaths. The trunk grows tall and can reach heights of up to 20 feet (6 meters) or more, depending on the variety, within a period of seven (7) months. At about 7 months, the trunk reaches its maximum size as the energy of the plant will shift to the growing fruit and the second generation of plants. The actual stem is a rhizome that grows underground. Banana plants have large, elongated, and wide leaves that can be as long as 9 feet (2.7 meters) and about 2 feet (0.6 meters) wide. The leaves grow in a spiral pattern around the trunk and as new leaves emerge, older ones gradually die off. In banana plants, the trunk is a prominent and unique feature that gives the plant its characteristic appearance. It is sometimes referred to as a “false stem” because it performs similar functions to a traditional stem but is structurally different.

Here are some key points about the trunk in banana plants:
a) Appearance: The trunk is composed of overlapping leaf sheaths that tightly encircle each other. As the plant grows, new leaves emerge from the center, and older leaves wither and remain as a part of the pseudo-stem, forming visible rings. An internal view of the sheaths will show a honey-comb design for purposes of storing water.
b) Strength and Support: The trunk provides excellent structural support to the banana plant, allowing it to grow quite tall without the need for a woody trunk. Some banana varieties can reach heights of up to 20 feet (6 meters) or more.
c) Storage and Transport: The trunk also plays a crucial role in storing water and nutrients, which helps the plant survive in periods of drought or other adverse conditions. It acts as a conduit for transporting water and nutrients from the roots to the upper parts of the plant.
d) Reproduction: The trunk contributes to the plant's reproduction process. Once the banana plant reaches maturity, it produces a large inflorescence, also known as the banana heart, from the center of the trunk. The flowers within the inflorescence eventually develop into clusters of bananas.
e) Lifespan: The trunk has a limited lifespan. After the banana plant fruits, the trunk that bore the fruit begins to die back. However, the plant produces new suckers (offshoots) from its underground rhizomes, which will grow into new plants which replace the old ones.
f) Harvesting: When bananas are cultivated for their fruit, the entire trunk is usually cut down after harvesting to make room for new shoots to grow. This process is part of the banana's cycle of growth and regeneration. The trunk becomes organic waste in the field and is left to rot, which provides some nutrients to the soil and new generation of plants.

Overall, the trunk is a vital and fascinating part of banana plants, contributing to their structural stability, reproductive process, and ability to store and transport nutrients. Its unique characteristics are one of the reasons why banana plants are such intriguing and valuable crops in many parts of the world. Indeed, bananas are the eighth most common crop grown in the world.

Banana plants require a tropical or subtropical climate with plenty of sunlight and well-drained soil. Banana plants require at least 8 to 10 millimeters of water a day. They are usually propagated through suckers, which are small shoots that grow from the base of mature plants. Banana plants are fast-growing, and under favorable conditions, they can produce fruit within 9 to 12 months. A typical hectare of bananas will have approximately 1,800 to 3,200 plants. By focusing on the offshoots, the banana plants can advance from one generation to the next. Once the fruit is harvested, the trunk is typically cut down to a height of about one meter. The residual trunk which is loaded with water and nutrients will nurture the next generation of plants. The residual trunk will eventually dry out and fall to the earth as organic material.

Extracting 102 fibrous materials from the banana organic materials must be done on site. On site extraction is required for a number of reasons. For example, the places where bananas are grown tend to be remote or underdeveloped. That means that it is difficult to access the banana organic materials for shipping to a processing area. In addition, the banana organic materials are large. This is why they are generally left to rot as organic waste. Therefore, the method 100 must account for on site processing.

FIG. 1 also shows that the method 100 can include separating 104 the nonfibrous materials and sap resulting from the extraction 102 from one another. The nonfibrous materials and sap are placed into metal V-shaped trays. The sap drains into the bottom of the tray. I.e., gravity allows the sap to drain from the nonfibrous materials, separating 104 the two components.

FIG. 1 further shows that the method 100 can include pressing 106 the nonfibrous materials. Typically, the nonfibrous materials are transferred to a conveyer system. The nonfibrous materials are transported to a rolling press where the sap water is squeezed out, thus leaving the nonfibrous materials in a damp state.

FIG. 1 moreover shows that the method 100 can include drying 108 the nonfibrous materials. The nonfibrous materials are typically dried at temperatures between 95° F. and 205° F. (35° C. to 96° C.). The drying process is essential for reducing the moisture content of the nonfibrous materials, making it suitable for various applications, such as horticulture, agriculture and soil improvement. In addition, drying reduces the weight of the nonfibrous materials, reducing transportation costs. The specific temperature used may vary slightly depending on the method of drying 108 and equipment employed, but it generally falls within this range to prevent the nonfibrous materials from overheating or losing its beneficial properties. It should be noted that because of the nonfibrous materials' unique capacity to retain water, it can often be difficult to dry the nonfibrous materials—it simply does not dry quickly outside, and, even if placed in the sun, may take days or weeks to dry. Therefore, the use of commercial dryer systems, using electricity or gas, is critical for industrial production.

FIG. 1 additionally shows that the method 100 includes shredding 110 the nonfibrous materials. To create a uniform texture and improve its overall structure, the nonfibrous materials may undergo shredding 110 or milling. This shredding 110 breaks down the nonfibrous materials into smaller particles thereby maximizing its characteristics and behaviors and making it more suitable for packaging and use in horticulture and agriculture applications. Often, the nonfibrous materials are reduced to 3 to 5 millimeters.

As part of the shredding 110, the nonfibrous materials can be converted to a micro-scale dimension. The process is completed by placing the nonfibrous materials in a jet mill, homogenizer or similar machinery wherein the nonfibrous materials is converted to its micro-state.

The conversion of the nonfibrous materials to its micro-state:
increases water absorption and retention
permits its use as a dry surfactant or wetting agent
increases root system activity in the plants
provides structure and greater porosity to the soil
Increases area for water retention thereby improving access to the water by the roots
reduces soil temperature and evaporation from heat through its thermal conductivity
reduces actual water usage
reduce or eliminate mold, mildew and/or fungus
allows for application of the banana biomass soil additive on crops and orchards through tilling or other agricultural soil treatment method
allows for application of the banana biomass soil additive in horticulture including greenhouses, nurseries, commercial and retail landscaping, municipal green space use, sports fields and golf courses

Moreover, the nonfibrous banana biomass soil additive can be converted to a nano-scale dimension. The conversion of the nonfibrous banana biomass soil additive to nano-scale materials is done by high pressure equipment to convert the micro particles into nano particles with increased surface area for better coverage and absorption capacity. Moreover, the conversion to micro or a nano organic material permits the application of the banana biomass soil additive to be applied to crops by tilling the banana biomass soil additive into the soil or application of the banana biomass soil additive to plants within the horticulture industry. By burying the banana biomass soil additive in the soil, it provides water storage below the surface and allows the roots of the plants to access the available stored water.

FIG. 1 also shows that the method 100 can include sterilizing 112 the nonfibrous banana biomass soil additive. Depending on the use, the banana biomass soil additive may be sterilized 112 using heat, infrared, steam or any other desired method to eliminate any harmful pathogens or pests that could potentially harm plants. Sterilization 112 is crucial, especially for products intended for use in seed starting and potting mixes as it retains nutrients but removes pathogens.

FIG. 1 further shows that the method 100 can include nutrient supplementation 114. The nonfibrous banana biomass soil additive, depending on its intended use, may have a variety of organic materials added to supplement its use. These are the primary nutrients that plants need in relatively large quantities and are present in the unsupplemented nonfibrous materials. The formulation would be determined by soil tests and/or through plant needs and would be specific to a particular area.
Nitrogen (N): Nitrogen is essential for the formation of proteins, enzymes, chlorophyll (which is crucial for photosynthesis), and many other vital plant compounds. It is crucial for overall growth and leafy green development.
Phosphorus (P): Phosphorus is necessary for energy transfer within the plant and plays a vital role in root development, flower and fruit formation, and overall plant growth.
Potassium (K): Potassium is involved in numerous physiological processes, including enzyme activation, water uptake and regulation, and overall plant health and disease resistance.
Calcium (Ca): Calcium is essential for cell wall structure and stability, root development, and proper functioning of cell membranes.
Magnesium (Mg): Magnesium is a component of chlorophyll and is essential for photosynthesis, energy transfer, and enzyme activation.
(S): Sulfur is a constituent of some amino acids and proteins, and it plays a role in chlorophyll formation and overall plant health.

The critical micronutrients for plant growth can be found in the nonfibrous banana biomass soil additive and/or can be added to supplement the nutrients in the nonfibrous banana biomass soil additive. These are nutrients that plants require in smaller quantities but are still essential for their growth and development.
Iron (Fe)
Manganese (Mn)
Zinc (Zn)
Copper (Cu)
Boron (B)
Molybdenum (Mo)
Chlorine (CI)
Nickel (Ni)

FIG. 1 additionally shows that the method 100 can include packaging 116 the nonfibrous banana biomass soil additive. After processing, the banana biomass soil additive is ready for packaging 116. It is typically bagged in various sizes, ranging from small packages for home gardeners to large bales for commercial applications. The bags are often made of durable plastic to protect the nonfibrous banana biomass soil additive from moisture and maintain its quality during storage and transportation. Proper labeling is applied to each package, providing essential information such as the product's name, brand, weight, instructions for use, and any additional details or warnings.

FIG. 1 moreover shows that the method 100 can include distribution 118 of the nonfibrous banana biomass soil additive. The packaged 116 banana biomass is distributed to gardening centers, nurseries, greenhouses, landscapers, commercial facilities, municipalities, farmers and other retailers, where customers can purchase it for their specific needs.

Banana biomass soil additive has a number of unique aspects that make it a novel and superior soil amendment for agriculture and horticulture. These unique features are identified as follows:
Banana biomass soil additive is hydrophilic; it attracts and loves water as opposed to hydrophobic materials such as forest and wood products, peat moss and coconut coir.
Banana biomass soil additive has an unparalleled capacity to store and conserve water through its unique natural features and attributes. This characteristic makes banana biomass soil additive an excellent product for drought-stricken and arid areas as well as the general reduction of water usage in other environments.
Banana biomass soil additive is a natural dry surfactant or wetting agent that can be used in place of chemical surfactants to prepare hydrophobic materials, such as forest products, peat moss or coconut coir, to absorb water.
Banana biomass soil additive can reduce evaporation and improve plant health. The stored water is accessible to the roots of the plants and can ensure a balanced source of water for plant development.
Banana biomass soil additive can be placed in the soil in a manner that keeps the water retention in the root zone and thereby more accessible to the plants.
Banana biomass soil additive is a thermal conductor that can reduce soil temperature in hot environments and thereby reduce evaporation.
Banana biomass soil additive provides structure to the soil which helps prevent soil collapse and compaction.
Banana biomass soil additive is highly nutrient-rich, assists in helping plants utilize existing organics and fertilizers and has the capacity to act as a disease suppressant thus protecting plant health.
Banana biomass soil additive can be produced as a cost-competitive price and is found in an unlimited abundance in Latin America and India through the industrialization of growing banana trunks rather than growing bananas for fruit.
Banana biomass soil additive does not damage the soil but actually regenerates the soil. Moreover, the Banana biomass soil additive is renewable. It can be grown and harvested throughout the year thereby providing a steady and consistent supply.
Banana biomass soil additive characteristics and qualities are not matched by the various soil amendments, garden mixes or materials including peat moss and coconut coir.
The banana biomass soil additive can be used in a micro or nano media that can be used to improve nutritional access and water storage below surface.
Banana biomass soil additive removes carbon dioxide unlike peat moss which puts carbon dioxide into the atmosphere, is non-renewable and which is being banned and limited throughout the world.
Banana biomass soil additive does not expand or bloat when inundated with water. It stays firm and retains its form or shape. It does not turn into mud or a slurry when over-watered.

The finished banana biomass soil additive can be used in a variety of ways and under different conditions. This flexible and versatile organic material has been shown to dramatically improve plants and soils. Examples of the use are as follows:
Banana biomass soil additive can be applied in multiple ways: a) it can be mixed into the soil, b) it can be placed on the sides and bottom of a hole where a plant is to be placed, and c) it can be placed on top of the soil to act as a thermal blanket. Additionally, one or more of these ways of use may be applied to a specific plant or project.
Banana biomass soil additive can be used for plants, trees and crops. Application can be done through the use of micro or nano material being released and tilled into the soil.
Banana biomass soil additive can be used in nurseries and greenhouses used to grow plants including flowers, vegetables, shrubs and trees. The banana biomass soil additive can be used in the pots and containers and in the soil to improve the plant growth.
Banana biomass soil additive can be used in commercial and residential landscaping. Banana biomass soil additive can be mixed into the soil at a superficial level or used for the planting of ornamentals, trees or other plants and placed under and around the plant as it is planted in the soil. The organic material can be used for the landscaping around millions of commercial buildings and on residential properties.
Banana biomass soil additive can be used by state and local governments for maintenance of its green spaces, medians, parks, golf courses and H buildings. Moreover, it can be used for all new plants, trees, and ornamentals. This use will allow the government to use less water.
In drought-stricken areas, banana biomass soil additive will help in reducing water usage while permitting water use. Many jurisdictions require farmers, homeowners and businesses to eliminate certain water usage. This organic material would permit these shareholders to continue to use water while reducing total water usage.
Banana biomass soil additive is extremely rich in micronutrients and restores nutrients to the soil, and the banana biomass soil additive may be infused with other nutrients such as potassium, nitrogen and calcium to further strengthen the plants. Hence, beyond its water retention capacity, the banana biomass soil additive can positively impact plant's nutritional health.
Banana biomass soil additive is additionally an excellent soil amendment for arid areas such as arid states in the western United States or countries in the Middle East. The reduction of water usage will conserve water and reduce costs.
Existing scientific papers have demonstrated the benefits of the banana sap with strawberries, onions, corn, cabbage, soybean and other crops. These studies validate the tremendous nutrient and water-savings benefits from banana sap. These same benefits apply to the banana biomaterial.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

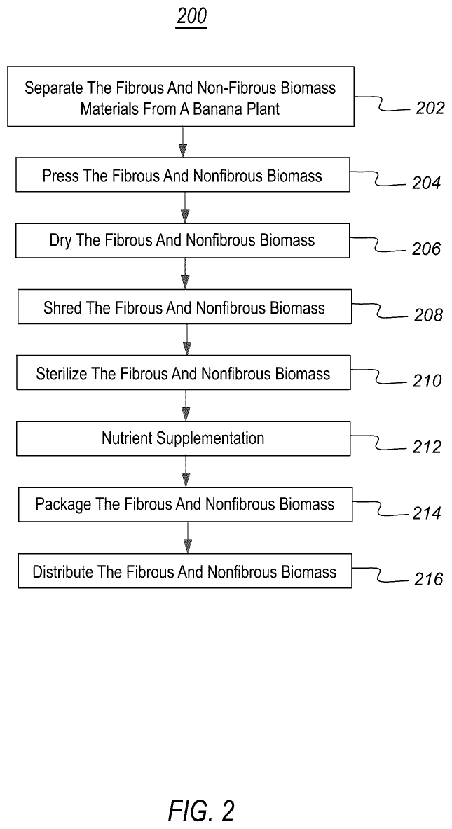

FIG. 2 is a flow-chart illustrating an example of an alternative method 200 for creating a banana biomass soil additive. The method 200 varies from the method 100 of FIG. 1 primarily in that the fibrous materials are also used as part of the banana biomass soil additive. The benefits of using both the fibrous and nonfibrous materials include those benefits previously described, and the addition of the fibrous material provides additional absorbency and structure to the banana biomass soil additive

FIG. 2 shows that the method 200 can include separating 202 the fibrous and nonfibrous materials from the sap. The fibrous and nonfibrous materials and sap are placed into metal V-shaped trays. The sap drains into the bottom of the tray. I.e., gravity allows the sap to drain from the fibrous and nonfibrous material, separating 202 the two components.

FIG. 2 further shows that the method 200 can include pressing 204 the fibrous and nonfibrous materials. Typically, the fibrous and nonfibrous materials is transferred to a conveyer system. The fibrous and nonfibrous materials is transported to a rolling press where the sap water is squeezed out, thus leaving the fibrous and nonfibrous material in a damp state.

FIG. 2 moreover shows that the method 200 can include drying 206 the fibrous and nonfibrous materials. The fibrous and nonfibrous materials is typically dried at temperatures between 95° F. and 205° F. (35° C. to 96° C.). The drying process is essential for reducing the moisture content of the fibrous and nonfibrous materials, making it suitable for various applications, such as gardening, horticulture, and soil improvement. In addition, drying reduces the weight of the fibrous and nonfibrous materials, reducing transportation costs. The specific temperature used may vary slightly depending on the method of drying 206 and equipment employed, but it generally falls within this range to prevent the fibrous and nonfibrous materials from overheating or losing its beneficial properties. It should be noted that because of the fibrous and nonfibrous materials' unique capacity to retain water, it can often be difficult to dry the fibrous and nonfibrous materials—it simply does not dry quickly outside, and, even if placed in the sun, may take days or weeks to dry. Consequently, the best methods of drying involve industrial dryers using electricity or gas.

FIG. 2 additionally shows that the method 200 can include shredding 208 the fibrous and nonfibrous materials. To create a uniform texture and improve its overall structure, the fibrous and nonfibrous materials may undergo shredding 208 or milling. This shredding 208 breaks down the fibrous and nonfibrous materials into smaller particles that maximize the beneficial characteristics and benefits to plants and soil. Likewise, this process makes it more suitable for packaging and use in agriculture and horticulture applications.

As part of the shredding 208, the fibrous and nonfibrous materials can be converted to a micro-scale dimension. The process is completed by placing the fibrous and nonfibrous materials in a jet mill grinder, dry mill or shredder wherein the fibrous and nonfibrous materials is converted to its micro-state.

The conversion of the fibrous and nonfibrous materials to its micro-state creates the final product known as banana biomass soil additive. Additionally, the banana biomass soil additive:
increases water absorption and retention
increases root system activity in the plants
increases area for water retention thereby improving access to the water by the roots
provides structure and greater porosity in the soil
results in a dry surfactant or wetting agent that can prepare hydrophobic material absorb water.
reduces soil temperature and evaporation from heat through its thermal conductivity
reduces actual water usage
reduce or eliminate mold, mildew and/or fungus
allows for application of the banana biomass soil additive on crops and orchards through tilling or other agricultural soil treatment method
allows for application of the banana biomass soil additive in horticulture including greenhouses, nurseries, commercial and retail landscaping, municipal green space use, sports fields and golf courses

Moreover, the nonfibrous banana biomass soil additive can be converted to a nano-scale dimension. The conversion of the nonfibrous banana biomass soil additive to nano-scale materials is done by high pressure equipment to convert the micro particles into nano particles with increased surface area for better coverage and absorption capacity. Moreover, the conversion to micro or a nano organic material permits the application of the Advanced Soil Additive to be applied to crops by tilling the banana biomass soil additive into the soil or application of the banana biomass soil additive to plants within the horticulture industry. By burying the banana biomass soil additive in the soil, it provides water storage below the surface and allows the roots of the plants to access the available stored water.

FIG. 2 also shows that the method 200 can include sterilizing 210 the fibrous and nonfibrous materials. Depending on the use, the fibrous and nonfibrous materials may be sterilized 210 using heat, infrared, steam or any other desired method to eliminate any harmful pathogens or pests that could potentially harm plants. Sterilization 210 is crucial, especially for products intended for use in seed starting and potting mixes as it retains nutrients but removes pathogens.

FIG. 2 further shows that the method 200 can include nutrient supplementation 212. The fibrous and nonfibrous materials, depending on its intended use, may have a variety of organic materials added to supplement its use. These are the primary nutrients that plants need in relatively large quantities and are present in the unsupplemented fibrous and nonfibrous materials. The formulation would be determined by soil tests and/or through plant needs and would be specific to a particular area.
Nitrogen (N): Nitrogen is essential for the formation of proteins, enzymes, chlorophyll (which is crucial for photosynthesis), and many other vital plant compounds. It is crucial for overall growth and leafy green development.
Phosphorus (P): Phosphorus is necessary for energy transfer within the plant and plays a vital role in root development, flower and fruit formation, and overall plant growth.
Potassium (K): Potassium is involved in numerous physiological processes, including enzyme activation, water uptake and regulation, and overall plant health and disease resistance.
Calcium (Ca): Calcium is essential for cell wall structure and stability, root development, and proper functioning of cell membranes.
Magnesium (Mg): Magnesium is a component of chlorophyll and is essential for photosynthesis, energy transfer, and enzyme activation.
Sulfur (S): Sulfur is a constituent of some amino acids and proteins, and it plays a role in chlorophyll formation and overall plant health.

The critical micronutrients for plant growth can be found in the fibrous and nonfibrous materials and/or can be added to supplement the nutrients in the fibrous and nonfibrous materials. These are nutrients that plants require in smaller quantities but are still essential for their growth and development.
Iron (Fe)
Manganese (Mn)
Zinc (Zn)
Copper (Cu)
Boron (B)
Molybdenum (Mo)
Chlorine (CI)
Nickel (Ni)

FIG. 2 additionally shows that the method 200 can include packaging 214 the fibrous and nonfibrous materials. After processing, the fibrous and nonfibrous materials is ready for packaging 214. It is typically bagged in various sizes, ranging from small packages for home gardeners to large bales for commercial applications. The bags are often made of durable plastic to protect the fibrous and nonfibrous materials from moisture and maintain its quality during storage and transportation. Proper labeling is applied to each package, providing essential information such as the product's name, brand, weight, instructions for use, and any additional details or warnings.

FIG. 2 moreover shows that the method 200 can include distribution 216 of the fibrous and nonfibrous materials. The packaged 214 banana biomass soil additive is distributed to gardening centers, nurseries, landscapers, commercial facilities, farmers and other retailers, where customers can purchase it for their specific needs.

Banana biomass soil additive has a number of unique aspects that make it a novel and superior soil amendment for agriculture and horticulture. These unique features are identified as follows:
Banana biomass soil additive is hydrophilic; it attracts and loves water as opposed to hydrophobic materials such as forest and wood products, peat moss and coconut coir.
Banana biomass soil additive has an unparalleled capacity to store and conserve water through its unique natural features and attributes. This characteristic makes banana biomass soil additive an excellent product for drought-stricken and arid areas as well as the general reduction of water usage in other environments.
Banana biomass soil additive is a natural dry surfactant or wetting agent that can be used in place of chemical surfactants to prepare hydrophobic materials, such as forest products, peat moss or coconut coir, to absorb water.
Banana biomass soil additive can reduce evaporation and improve plant health. The stored water is accessible to the roots of the plants and can ensure a balanced source of water for plant development.
Banana biomass soil additive can be placed in the soil in a manner that keeps the water retention in the root zone and thereby more accessible to the plants.
Banana biomass soil additive is a thermal conductor that can reduce soil temperature in hot environments and thereby reduce evaporation.
Banana biomass soil additive provides structure to the soil and greater porosity which reduces soil collapse and compaction.
Banana biomass soil additive is highly nutrient-rich, assists in helping plants utilize existing organics and fertilizers and has the capacity to act as a disease suppressant thus protecting plant health.
Banana biomass soil additive can be produced as a cost-competitive price and is found in an unlimited abundance in Latin America and India through the industrialization of growing banana trunks rather than growing bananas for fruit.
Banana biomass soil additive does not damage the soil but actually regenerates the soil. Moreover, the Banana biomass soil additive is renewable. It can be grown and harvested throughout the year thereby providing a steady and consistent supply.
Banana biomass soil additive characteristics and qualities are not matched by the various soil amendments, garden mixes or materials including peat moss and coconut coir.
The banana biomass soil additive can be used in a micro or nano media that can be used to improve nutritional access and water storage below surface.
Banana biomass soil additive removes carbon dioxide unlike peat moss which puts carbon dioxide into the atmosphere, is non-renewable and which is being banned and limited throughout the world.
Banana biomass soil additive does not expand or bloat when inundated with water. It stays firm and retains its form or shape. It does not turn into mud or a slurry when over-watered.

The finished banana biomass soil additive can be used in a variety of ways and under different conditions. This flexible and versatile organic material has been shown to dramatically improve plants and soils. Examples of the use are as follows:
Banana biomass soil additive as an advanced soil additive can be applied in multiple ways: a) it can be mixed into the soil, b) it can be placed on the sides and bottom of a hole where a plant is to be placed, and c) it can be placed on top of the soil to act as a thermal blanket. Additionally, one or more of these ways of use may be applied to a specific plant or project.
Banana biomass soil additive can be used for plants, trees and crops. Application can be done through the use of micro or nano material being released and tilled into the soil.
Banana biomass soil additive can be used in nurseries and greenhouses used to grow plants including flowers, vegetables, shrubs and trees. The banana biomass soil additive can be used in the pots and containers and in the soil to improve the plant growth.
Banana biomass soil additive can be used in commercial and residential landscaping. Banana biomass soil additive can be mixed into the soil at a superficial level or used for the planting of ornamentals, trees or other plants and placed under and around the plant as it is planted in the soil. The organic material can be used for the landscaping around millions of commercial buildings and on residential properties.
Banana biomass soil additive can be used by state and local governments for maintenance of its green spaces, medians, parks, golf courses and buildings. Moreover, it can be used for all new plants, trees, and ornamentals. This use will allow the government to use less water.
In drought-stricken areas, banana biomass soil additive will help in reducing water usage while permitting water use. Many jurisdictions require farmers, homeowners and businesses to eliminate certain water usage. This organic material would permit these shareholders to continue to use water while reducing total water usage.
Banana biomass soil additive is extremely rich in micronutrients and restores nutrients to the soil, and the banana biomass soil additive may be infused with other nutrients such as potassium, nitrogen and calcium to further strengthen the plants. Hence, beyond its water retention capacity, the banana biomass soil additive can positively impact plant's nutritional health.
Banana biomass soil additive is additionally an excellent soil amendment for arid areas such as arid states in the western United States or countries in the Middle East. The reduction of water usage will conserve water and reduce costs.
Existing scientific papers have demonstrated the benefits of the banana biomass sap with strawberries, onions, corn, cabbage, soybean and other crops. These studies validate the tremendous nutrient and water-savings benefits from banana sap. These same benefits apply to the banana biomaterial.

Different analyses have been performed of banana biomass soil additive as a soil amendment and water retention properties, with results below. First, an experiment was performed to determine water uptake of banana biomass soil additive versus coconut coir pith. Two separate containers of water were mixed as follows: 5.29 ounces of 16% coconut coir pith mixed with soil and 5.29 ounces of 16% banana biomass soil additive mixed with soil. Each mixture was placed in separate containers with release holes located on the bottom. Each container was watered with 42.3 ounces of water. Each container had the same final weight. The water was permitted to percolate through the soil with the expectation that a portion of the water would be released from the container. Seven minutes passed, and any water that was released from the container was captured on a tray and poured into a measuring cup and weight to determine water loss. After waiting seven minutes, the banana biomass soil additive retained 100% of the water and the coconut coir pith retained 73% of the water, as shown in Table 1.

TABLE 1
Water Retention Test

| | | Water | Water | |
|---|---|---|---|---|
| | Soil | Applied | Retained | % Water |
| Material | Amendment | (oz) | (oz) | Lost |
| Coconut Coir Pith | 5.29 | 42.3 | 31.4 | 27% |
| Banana Biomass | 5.29 | 42.3 | 42.3 | 0% |
| Soil Additive | | | | |

Another test was conducted to see water available to germinating plants. Two trays were prepared. The first included 10% of banana biomass soil additive mixed with soil. The second included 30% of coconut coir pith mixed with soil. Each tray was of equal size and had six bean seeds planted 1 inch deep equidistant from one another in the tray. During the experiment the humidity averaged approximately 36%. The average temperature was 93° F. The trays were placed in a location with adequate sunlight. The plants were watered regularly to keep the substrates moist but not overly saturated. The two trays were tracked on a daily basis and weekly growth parameters for 60 days. After two weeks the height of the plants was approximately equal in the two trays. The banana biomass soil additive tray was watered at a slower rate (approximately ⅓ less water) because of water retention within the tray. For the final 30 days of the test, water was withheld from both trays. During this period, the condition of the bean plants began to deteriorate until such time as the beans died in the coconut coir pith tray. The beans died in the coconut coir pith tray at day 22. While the water moisture level reached 0 on day 13, the bean plants continued to live for an additional 9 days until they were considered dead. For the last 30 days of the banana biomass soil additive tray, the moisture level reduced at a significantly slower pace than that of the coconut coir pith tray. At the end of the test, the banana biomass soil additive tray continued to have 17% moisture. The bean plants grew to a height of 12 inches and maintained healthy color through much of the 30 days. By the final ten days, the beans began to manifest stress and several leaves began to turn yellow. By the end of the 30 days, the bean plants were uniformly stressed but had sufficient color. It was evident that the beans had access to the water because of their longevity and had some level of uptake from the nutrients in the banana biomass soil additive.

An additional test was conducted to determine water retention at extreme temperatures. The test compared 10% of banana biomass soil additive mixed with soil versus 40% of coconut coir pith mixed with soil and 40% of peat moss mixed with soil, each placed in trays. The trays were placed in a heat tunnel for a period of eight hours. The trees were then left at room temperature at 72° F. for a period of 12 hours and then placed in the heat tunnel for an additional 12 hours. The final moisture loss over the 32 hour period was 42.5% for the banana biomass soil additive, 61.3% for the peat moss, and 51.4% for the coconut coir pith. In these tests, the heat averaged approximately 116° F.

A test was conducted to determine the insulating capacity of banana biomass soil additive. A square foot of soil to a depth of four inches was excavated from a location in Charlotte, NC situated in an area that received 8 hours of sunshine a day. 6 grams of the banana biomass soil additive were mixed in with the soil. Then the soil was replaced in the excavated hole. A control square foot was likewise maintained to evaluate the temperature in an undisturbed area. The temperature of the two soil plots were measured on a daily basis in five-day blocks over 30 days (7 total measurements). The test results demonstrated that the banana biomass r soil additive educed the soil temperature when compared against the control plot. The average temperature reduction was approximately 12% per time block. The test demonstrated that banana biomass soil additive was able to reduce soil temperature while acting as an insulation from heat.

Another test was conducted to determine the efficacy of banana biomass soil additive in growing bluegrass under stressed conditions through the limitation of access to water. A first tray was prepared using only garden soil. A second tray was prepared using a mixture of garden soil and 3.5% banana biomass soil additive. A third tray was prepared using a mixture of garden soil and 5% biomass soil additive. Bluegrass seed was planted in each tray and the trays were placed under heat lamps in a controlled room with humidity of 55% and a static temperature of 72⁰. The grass was allowed to germinate and grow in each tray. It was observed that the trays containing the banana biomass soil additive caused quicker germination compared to the control tray. Once the grass was established, the amount of water given to the grass was reduced. The grass in the control tray began to turn brown after 15 days with limited water. The end of the study, the control grass was dead. The grass in the 3.5% banana biomass soil additive continued turned brownish green but remained alive. The grass in the 5% banana biomass soil additive tray retained a healthy green color for the duration of the test. A second test was conducted with another brand of garden soil with similar results.

A test was conducted wherein 40 grams of peat moss was placed inside of a pot and subsequently watered with 150 millimeters of water. After 10 minutes, the pot was cut open, and 90% of the peat moss did not absorb water but continued to be dried. Likewise, 20 grams of coconut coir pith were placed inside of a pot and watered with 150 millimeters of water. After 10 minutes, the pot was cut open, and approximately 90% of the coconut coir pith was dry having absorbed no water. Thereafter, the same test was conducted, however, with the peat moss, 3 grams of banana biomass soil additive was mixed with the peat moss, and with the coconut coir pith, 2 grams of banana biomass soil additive was mixed into the coconut coir. Thereafter, 150 millimeters were added to each pot. After 10 minutes, each pot was cut open. In both the peat moss pot and the coconut coir pith pot, 100% of the peat moss and coconut coir pith was wet having absorbed water by the inclusion of the banana biomass soil additive.

The present invention may be embodied in other specific forms without departing from its spirit or essential characteristics. The described embodiments are to be considered in all respects only as illustrative and not restrictive. There have been exhaustive tests, studies and analysis of the banana biomass soil additive over a 4 year period that further support the examples given above. The scope of the invention is, therefore, indicated by the appended claims rather than by the foregoing description. All changes which come within the meaning and range of equivalency of the claims are to be embraced within their scope.

What is claimed is:

1. A method for creating a banana biomass soil additive from banana organic materials, the method comprising:
separating the fibrous and non-fibrous materials of at least one portion of a banana plant from the other banana organic materials;
pressing the fibrous and nonfibrous materials to remove all remaining water; and
drying the fibrous and nonfibrous materials.

2. The method of claim 1, wherein separating the fibrous and nonfibrous materials from the other banana organic materials includes placing the combination of fibrous and nonfibrous materials and sap in a V-shaped tray.

3. The method of claim 1 wherein pressing the fibrous and nonfibrous materials includes placing the fibrous and nonfibrous materials on a conveyer and passing it through a rolling press.

4. The method of claim 1, wherein drying the fibrous and nonfibrous materials includes heating the fibrous and nonfibrous materials to between 95° F. and 205° F.

5. The method of claim 1 further comprising nutrient supplementation.

6. The method of claim 5 wherein nutrient supplementation includes adding at least one of:
Nitrogen;
Phosphorus;
Potassium;
Calcium;
Magnesium; or
Sulfur.

7. The method of claim 1 wherein nutrient supplementation includes adding at least one of:
Iron;
Manganese;
Zinc;
Copper;
Boron;
Molybdenum;
Chlorine; or
Nickel.

8. A method for creating a banana biomass soil additive from banana organic materials, the method comprising:
separating the fibrous materials of at least one portion of a banana plant from the nonfibrous materials and sap;
separating the nonfibrous materials from the sap;
pressing the nonfibrous materials;
drying the nonfibrous materials;
shredding the nonfibrous materials; and
sterilizing the nonfibrous materials.

9. The method of claim 8 wherein shredding the nonfibrous materials includes converting the nonfibrous materials to a micro-scale dimension.

10. The method of claim 9 wherein converting the nonfibrous materials to a micro-scale dimension includes placing the nonfibrous materials in at least one of:
a water jet mill;
a dry mill; or
a mechanized shredder.

11. The method of claim 10 wherein shredding the nonfibrous materials includes converting the nonfibrous materials to a nano-scale dimension.

12. The method of claim 11 wherein converting the nonfibrous materials to a nano-scale dimension includes placing the nonfibrous materials in high pressure equipment.

13. The method of claim 8 wherein sterilizing the nonfibrous materials is accomplished using at least one of:
heat,
infrared; or
steam.

14. The method of claim 8 further comprising packaging in at least one of a bag;
a sack;
a note; or
a bail.

15. The method of claim 8 further comprising distribution to at least one of commercial markets; or
retail markets.

16. A banana biomass soil additive, the banana biomass soil additive comprising:
fibrous and nonfibrous materials, wherein the fibrous and nonfibrous materials have been obtained by the steps of:
separating the fibrous and nonfibrous materials of at least one portion of a banana plant from the other banana organic materials including the sap;
pressing the fibrous and nonfibrous materials; and
drying the fibrous and nonfibrous materials.

17. The banana biomass soil additive of claim 16 wherein the banana biomass soil additive increases the water retention of the soil.

18. The banana biomass soil additive of claim 16 wherein the banana biomass soil additive functions as a dry organic surfactant.

19. The banana biomass soil additive of claim 16 wherein the banana biomass soil additive insulates the soil.

20. The banana biomass soil additive of claim 17 wherein the banana biomass soil additive provides structure and porosity to the soil.
